(19) United States
(12) Patent Application Publication
(10) Pub. No.: US 2012/0152897 A1
(43) Pub. Date: Jun. 21, 2012

(54) METHOD OF THINNING GLASS SUBSTRATE

(75) Inventors: Chih-Wei Cheng, Taichung City (TW); Chung-Ming Chen, Kaohsiung County (TW)

(73) Assignee: CHUNGHWA PICTURE TUBES, LTD., Taoyuan (TW)

(21) Appl. No.: 13/034,692

(22) Filed: Feb. 24, 2011

(30) Foreign Application Priority Data
Dec. 21, 2010 (TW) 99144962

(51) Int. Cl. C03C 15/02; B24B 1/00

(52) U.S. Cl. 216/52

(57) ABSTRACT

A method of thinning a glass substrate includes following steps. A glass substrate is provided. A first etching process is performed on the glass substrate, so as to reduce a thickness of the glass substrate. A polishing process is performed on the thinned glass substrate, so that the thickness of the glass substrate is reduced again. A first treated surface is formed on the glass substrate. The center-line average roughness of the first treated surface ranges from about 100 angstroms (Å) to about 300 angstroms (Å). A second etching process is performed on the first treated surface of the glass substrate, so as to form a second treated surface. The center-line average roughness of the second treated surface ranges from about 10 angstroms (Å) to about 50 angstroms (Å).

### CROSS-REFERENCE TO RELATED APPLICATION

This application claims the priority benefit of Taiwan application serial no. 99144962, filed on Dec. 21, 2010. The entirety of the above-mentioned patent application is hereby incorporated by reference herein and made a part of this specification.

### BACKGROUND OF THE INVENTION

1. Field of the Invention

The invention relates to a thinning method. More particularly, the invention relates to a method of thinning a glass substrate.

2. Description of Related Art

At present, flat panel displays (e.g., liquid crystal flat panel displays, organic electro-luminescence displays, and plasma displays) have been widely applied to consumer electronic products or computer products, such as medium and small portable televisions (TVs), mobile phones, camcorders, notebook computers, desktop displays, projection TVs, and so on. However, due to the demands of the market, the screens of the flat panel displays have been generally trending towards large size and light weight.

According to the related art, the weight and the thickness of the flat panel display can be reduced by thinning a substrate of the display. Nevertheless, the bending strength of the thinned substrate is reduced, thus decreasing the reliability of the substrate. In particular, when the substrate has large dimensions, the reliability of the substrate is further reduced. Therefore, if the display panel is damaged because of external forces during transport, the overall production yield in the manufacturing process of the display panel may be decreased. As a result, how to reinforce the thinned substrate has become a major challenge with respect to fabrication of the display panel.

### SUMMARY OF THE INVENTION

The invention is directed to a method of thinning a glass substrate. By applying the method, the strength of the thinned glass substrate can be enhanced.

In an embodiment of the invention, a method of thinning a glass substrate includes following steps. A glass substrate is provided. A first etching process is performed on the glass substrate, such that a thickness of the glass substrate is reduced. A polishing process is performed on the thinned glass substrate to reduce the thickness of the glass substrate again, and a first treated surface is formed on the glass substrate. Here, the center-line average roughness of the first treated surface ranges from about 100 angstroms (Å) to about 300 angstroms (Å). A second etching process is performed on the first treated surface of the glass substrate to form a second treated surface. Here, the center-line average roughness of the second treated surface ranges from about 10 angstroms (Å) to about 50 angstroms (Å).

According to an embodiment of the invention, the strength of thinned the glass substrate ranges from about 55 Nt to about 65 Nt after the polishing process is performed on the thinned glass substrate.

According to an embodiment of the invention, the strength of the glass substrate ranges from about 70 Nt to about 80 Nt after the second etching process is performed on the first treated surface of the glass substrate.

According to an embodiment of the invention, an etching rate of the first etching process ranges from about 0.05 μm/s to about 0.1 μm/s.

According to an embodiment of the invention, an etching rate of the second etching process ranges from about 0.05 μm/s to about 0.1 μm/s.

According to an embodiment of the invention, the polishing process includes a chemical mechanical polishing (CMP) process or an electrochemical polishing (ECP) process.

According to an embodiment of the invention, the first etching process includes an isotropic etching process or an anisotropic etching process.

According to an embodiment of the invention, the second etching process includes an isotropic etching process or an anisotropic etching process.

According to an embodiment of the invention, a thickness of the glass substrate ranges from about 400 micrometers to about 1000 micrometers after the polishing process is performed.

Based on the above, in the method of thinning the glass substrate described in the embodiments of the invention, after the first etching process and the polishing process are performed, the second etching process is performed to disperse stress on the surface of the glass substrate. Therefore, stress concentration can be effectively prevented, and the strength of the thinned glass substrate can be further enhanced.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic flow chart illustrating a method of thinning a glass substrate according to an embodiment of the invention.

FIG. 2A to FIG. 2D are schematic cross-sectional views illustrating the method of thinning the glass substrate depicted in FIG. 1.

### DESCRIPTION OF EMBODIMENTS

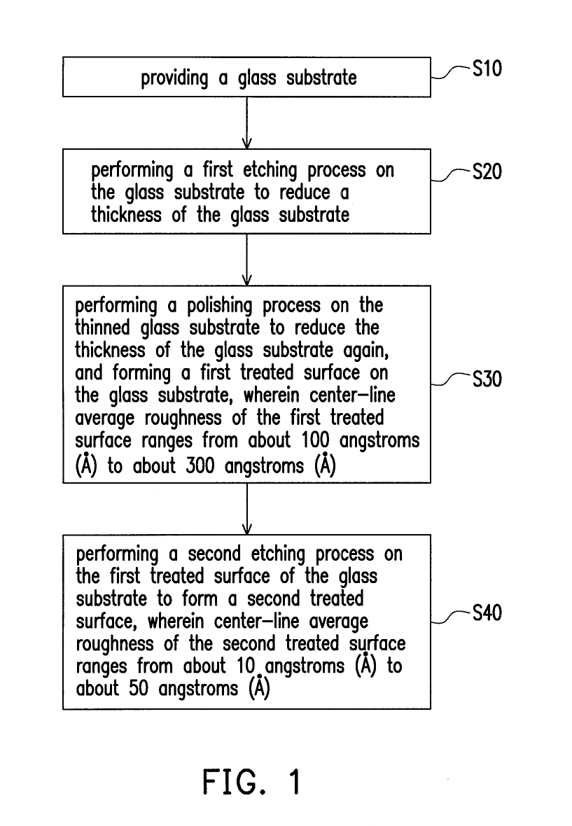

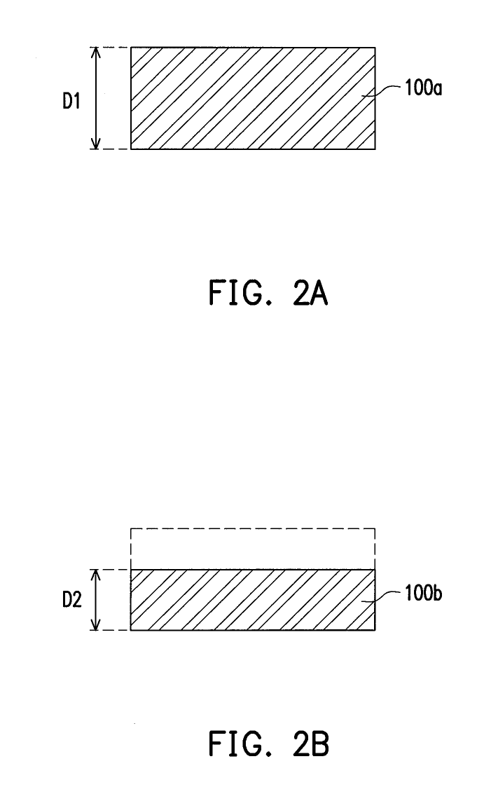

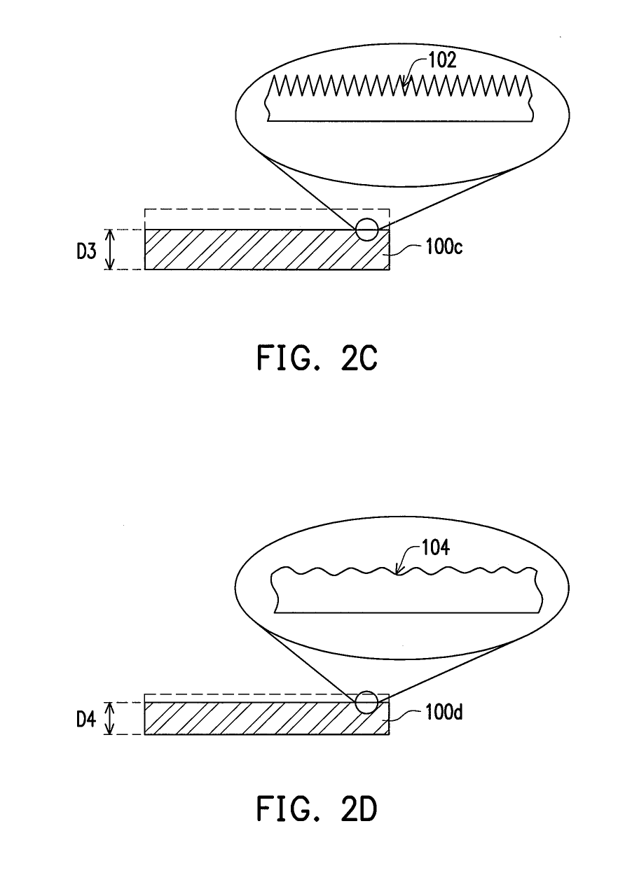

FIG. 1 is a schematic flow chart illustrating a method of thinning a glass substrate according to an embodiment of the invention. FIG. 2A to FIG. 2D are schematic cross-sectional views illustrating the method of thinning the glass substrate depicted in FIG. 1. It should be noted that the same or similar elements are indicated by the same or similar reference numbers in the embodiments described below, and the descriptions of the same technical details are therefore not repeated here. With reference to FIG. 1 and FIG. 2A, the method of thinning the glass substrate in this embodiment includes following steps. In step S10, a glass substrate 100a is provided. The glass substrate 100a has a first thickness D1 that ranges from about 0.4 mm to about 1 mm, for instance, which should however not be construed as a limitation to the invention.

With reference to FIG. 1 and FIG. 2B, in step S20, a first etching process is performed on the glass substrate 100a, so as to reduce the first thickness D1 of the glass substrate 100a and form a glass substrate 100b having a second thickness D2. Here, the second thickness D2 ranges from about 0.4 mm to about 1 mm, for instance, and the second thickness D2 is smaller than the first thickness D1. In addition, the etching rate of the first etching process performed on the glass substrate 100a ranges from about 0.05 μm/s to about 0.1 μm/s in this embodiment, for instance, which should however not be construed as a limitation to the invention. The first etching process is an isotropic etching process or an anisotropic etching process, for instance.

With reference to FIG. 1 and FIG. 2C, in step S30, a polishing process is performed on the thinned glass substrate 100b, so as to further reduce the second thickness D2 of the glass substrate 100b and form a glass substrate 100c having a third thickness D3. In addition, a first treated surface 102 is formed on the glass substrate 100c. In this embodiment, the center-line average roughness of the first treated surface 102 ranges from about 100 angstroms (Å) to about 300 angstroms (Å), for instance, and the strength of the glass substrate 100c ranges from about 55 Nt to about 65 Nt. According to this embodiment, the polishing process includes a chemical mechanical polishing (CMP) process or an electrochemical polishing (ECP) process.

As indicated in FIG. 1 and FIG. 2D, in step S40, a second etching process is performed on the first treated surface 102 of the glass substrate 100c, so as to form a glass substrate 100d having a second treated surface 104. Here, the center-line average roughness of the second treated surface 104 ranges from about 10 angstroms (Å) to about 50 angstroms (Å), for instance, and the strength of the glass substrate 100d ranges from about 70 Nt to about 80 Nt. In addition, the etching rate of the second etching process performed on the glass substrate 100c ranges from about 0.05 μm/s to about 0.1 μm/s in this embodiment, for instance, which should however not be construed as a limitation to the invention. Here, the second etching process includes an isotropic etching process or an anisotropic etching process, for instance. The glass substrate 100d has a fourth thickness D4 ranging from about 400 μm to about 1000 μm. So far, the process of thinning the glass substrate 100a is completed.

In the method of thinning the glass substrate described in this embodiment, after the polishing process is performed, the second etching process is performed on the first treated surface 102 of which the center-line average roughness ranges from about 100 angstroms (Å) to about 300 angstroms (Å), so as to form the second treated surface 104 having the center-line average roughness that ranges from about 10 angstroms (Å) to about 50 angstroms (Å). As such, the stress on the first treated surface 102 on which the polishing process is performed can be effectively dispersed. That is to say, the stress can be evenly distributed onto the second treated surface 104, so as to prevent the insufficient strength of the glass substrate 100c caused by the concentrated stress. Namely, in this embodiment, through performing the second etching process, stress concentrated on the first treated surface 102 on which the polishing process is performed can be effectively prevented, and the strength of the thinned glass substrate 100d can be enhanced.

In addition, the method of thinning the glass substrate described in the embodiment can also be applied to a display panel. Namely, the thinning process can be performed on an outer surface of the substrate of the display panel, so as to reduce the thickness of the entire display panel and enhance the structural strength thereof.

Note that the fabrication process illustrated in FIG. 1 and FIG. 2A to FIG. 2D is exemplary and can be adjusted or modified by one having ordinary skill in the art based on manufacturing demands, and therefore no relevant descriptions are further provided hereinafter.

In light of the foregoing, according to the method of thinning the glass substrate described in the embodiments of the invention, after the first etching process and the polishing process are performed, the second etching process is performed to disperse stress on the surface of the glass substrate. Therefore, stress concentration can be effectively prevented, and the strength of the thinned glass substrate can be further improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of thinning a glass substrate, comprising:
providing a glass substrate;
performing a first etching process on the glass substrate to reduce a thickness of the glass substrate;
performing a polishing process on the thinned glass substrate to reduce the thickness of the glass substrate again, and forming a first treated surface on the glass substrate, wherein center-line average roughness of the first treated surface ranges from about 100 angstroms (Å) to about 300 angstroms (Å); and
performing a second etching process on the first treated surface of the glass substrate to form a second treated surface, wherein center-line average roughness of the second treated surface ranges from about 10 angstroms (Å) to about 50 angstroms (Å).

2. The method of thinning the glass substrate as claimed in claim 1, wherein strength of the thinned glass substrate ranges from about 55 Nt to about 65 Nt after the polishing process is performed on the thinned glass substrate.

3. The method of thinning the glass substrate as claimed in claim 1, wherein strength of the glass substrate ranges from about 70 Nt to about 80 Nt after the second etching process is performed on the first treated surface of the glass substrate.

4. The method of thinning the glass substrate as claimed in claim 1, wherein an etching rate of the first etching process ranges from about 0.05 μm/s to about 0.1 μm/s.

5. The method of thinning the glass substrate as claimed in claim 1, wherein an etching rate of the second etching process ranges from about 0.05 μm/s to about 0.1 μm/s.

6. The method of thinning the glass substrate as claimed in claim 1, wherein the polishing process comprises a chemical mechanical polishing process or an electrochemical polishing process.

7. The method of thinning the glass substrate as claimed in claim 1, wherein the first etching process comprises an isotropic etching process or an anisotropic etching process.

8. The method of thinning the glass substrate as claimed in claim 1, wherein the second etching process comprises an isotropic etching process or an anisotropic etching process.

9. The method of thinning the glass substrate as claimed in claim 1, wherein a thickness of the glass substrate ranges from about 400 micrometers to about 1000 micrometers after the polishing process is performed.
